(19) United States
(12) Patent Application Publication
(10) Pub. No.: US 2007/0058676 A1
(43) Pub. Date: Mar. 15, 2007

(54) System and method for transmitting/receiving a signal in a communication system

(75) Inventors: Chi-Woo Lim, Suwon-si (KR); Gyu-Bum Kyung, Suwon-si (KR); Dong-Seek Park, Yongin-si (KR); Jae-Yoel Kim, Suwon-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/496,123

(22) Filed: Jul. 31, 2006

(30) Foreign Application Priority Data
Jul. 29, 2005 (KR) 10-2005-0069897

(51) Int. Cl. H04J 3/22

(52) U.S. Cl. 370/468

(57) ABSTRACT

Disclosed is a method for transmitting a signal in a signal transmission system, which includes demultiplexing a bit stream to be transmitted into a first bit stream and a second bit stream; generating a first coded bit stream by coding the first bit stream according to a first coding rate and generating a second coded bit stream by coding the second bit stream according to a second coding rate; and generating a coded symbol by concatenating the first coded bit stream and the second coded bit stream.

### PRIORITY

This application claims the benefit under 35 U.S.C. §119(a) of an application filed in the Korean Industrial Property Office on Jul. 29, 2005 and assigned Serial No. 2005-69897, the contents of which are incorporated herein by reference.

### BACKGROUND OF THE INVENTION

1. Field of the Invention

The present invention relates to a system and a method for signal transmission/reception in a communication system, and more particularly to a system and a method for transmitting and receiving Channel Quality Information (CQI).

2. Description of the Related Art

Communication systems are developing to provide users with services having various Qualities Of Service (QoSs) and supporting a high transmission speed. For the current communication systems, research has been actively pursued to develop a new type of communication system ensuring mobility and QoS in a BWA communication system such as a wireless Local Area Network (LAN) system and a wireless Metropolitan Area Network (MAN) system. Representatives of such new type communication systems are the Institute of Electrical and Electronics Engineers (IEEE) 802.16a/d communication system and the IEEE 802.16e communication system.

In a wireless channel environment such as the IEEE 802.16e communication system, change of channels according to passage of time is more extreme than that in the wired environment. Therefore, in order to acquire a high efficiency transmission performance, it is necessary to determine an optimum transmission scheme at every transmission time point and transmit/receive signals according to the determined optimum transmission scheme. As used herein, the term “transmission scheme” is a general term for all schemes used for signal transmission and reception, which includes a modulation scheme, a coding rate, and a transmission power. In order to determine the optimum transmission scheme, the Base Station (BS) must recognize exact CQI of each Mobile Station (MS). In order for the BS to recognize exact CQI of each MS, each MS must periodically transmit or feedback the CQI, which has been measured from a downlink signal, to the BS.

Further, the CQI is information which is indispensable in order to use a Hybrid Automatic Repeat Request (H-ARQ) scheme, an Adaptive Modulation and Coding (AMC) scheme, a Dynamic Channel Allocation (DCA) scheme, etc. However, because the CQI is not actual user data but is control data, it may act as a system overhead.

The IEEE 802.16e communication system supports two types of feedback schemes in accordance with the sub-channel allocation schemes. The sub-channel allocation schemes can be briefly classified into a diversity sub-channel allocation scheme and a band AMC sub-channel allocation scheme. According to the diversity sub-channel allocation scheme, one or more sub-carriers are selected from a plurality of sub-carriers within the entire frequency band used in the 802.16e communication system, and one diversity sub-channel is generated by using the selected sub-carriers and is then allocated to a corresponding MS. In contrast, according to the band AMC sub-channel allocation scheme, one or more sub-carriers are selected from a plurality of sub-carriers within specific frequency bands adjacent to each other, and one diversity sub-channel is generated using the selected sub-carriers and is then allocated to a corresponding MS.

When the band AMC sub-channel allocation scheme is used in the IEEE 802.16e communication system, the MS selects a predetermined number of bands (e.g. five bands), which include bands having the best and sequentially next best channel qualities, e.g. bands having the highest and sequentially next highest Carrier to Interference and Noise Ratio (CINR) values, from among the entire bands of the IEEE 802.16e communication system. Then, the MS feedsback band indexes and CINR values of the selected bands to the BS. At this time, the CINR is used as CQI and is expressed using a predetermined number of bits (e.g. five bits). The feedback of the CINR value for each of the multiple (e.g. five) bands results in overhead to the entire system.

Therefore, there has been a requirement for a scheme which can achieve reliable CQI transmission/reception by using a reduced number of bits, while minimizing system overhead.

### SUMMARY OF THE INVENTION

Accordingly, the present invention has been made to solve the above-mentioned problems occurring in the prior art, and an object of the present invention is to provide a system and method for transmission/reception of CQI in a communication system.

It is another object of the present invention to provide a system and method, which can reliably transmit and receive CQI using structured block Low Density Parity Check (LDPC) codes supporting a variable coding rate in a communication system.

In order to accomplish this object, there is provided a method for transmitting a signal in a signal transmission system, includes demultiplexing a bit stream to be transmitted into a first bit stream and a second bit stream; generating a first coded bit stream by coding the first bit stream according to a first coding rate and generating a second coded bit stream by coding the second bit stream according to a second coding rate; and generating a coded symbol by concatenating the first coded bit stream and the second coded bit stream.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram which schematically illustrates the structure of a CQI transmission system according to the present invention;

FIG. 2 is a block diagram which schematically illustrates the structure of a CQI reception system according to the present invention;

FIG. 3 is a flowchart of the process for CQI transmission according to the present invention;

FIG. 4 is a flowchart of the process for CQI reception according to the present invention;

FIG. 5 is a view schematically illustrating a process for generating a parity check matrix of structured block LDPC codes using a shortening scheme according to the present invention;

FIG. 6 is a view schematically illustrating a process for generating a parity check matrix of structured block LDPC codes using an elimination scheme according to the present invention;

FIG. 7 is a view schematically illustrating a process for generating a parity check matrix of structured block LDPC codes using a puncturing scheme according to the present invention;

FIGS. 8A through 8D are views illustrating the function of a node corresponding to a parity punctured during the decoding of the codeword of the structured block LDPC code generated by the puncturing scheme according to the present invention;

FIG. 9 is a view schematically illustrating parity check matrix of structured block LDPC codes using a shortening scheme according to the present invention; and

FIG. 10 is a view illustrating a parity check matrix of structured block LDPC codes supporting variable coding rates according to the present invention.

### DETAILED DESCRIPTION OF THE PREFERRED EMBODIMENT

Hereinafter, preferred embodiments of the present invention will be described with reference to the accompanying drawings. In the following description, a detailed description of known functions and configurations incorporated herein will be omitted when it may make the subject matter of the present invention rather unclear.

The present invention provides a system and a method for transmitting and receiving Channel Quality Information (CQI) in a communication system, for example, an Institute of Electrical and Electronics Engineers (IEEE) 802.16e communication system. In particular, the present invention provides a system and a method for transmitting and receiving CQI by using structured block Low Density Parity Check (LDPC) codes supporting a variable coding rate in an IEEE 802.16e communication system. For convenience of description, the present invention is described herein with reference to an IEEE 802.16e communication system. However, it goes without saying that the present invention can be applied to other communication systems in addition to the IEEE 802.16e communication system.

Hereinafter, a scheme for transmitting and receiving CQI by using structured block LDPC codes of the present invention will be described.

First, a scheme for the CQI transmission, that is, the CQI feedback, which is used in the present invention, will be described.

As described above, the IEEE 802.16e communication system employs different CQI feedback schemes according to sub-channel allocation schemes. However, for convenience of description, the CQI feedback scheme will be described hereinafter only for the case where the IEEE 802.16e communication scheme uses a band Adaptive Modulation and Coding (AMC) sub-channel allocation scheme. In the IEEE 802.16e communication scheme using the band AMC sub-channel allocation scheme, a Mobile Station (MS) selects a predetermined number of bands (e.g. five bands), which include bands having the best and sequentially next best channel qualities, e.g. bands having the highest and sequentially next highest Carrier to Interference and Noise Ratio (CINR) values, from among the entire bands of the IEEE 802.16e communication system. Then, the MS feedsback band indexes and CINR values of the selected five bands to the BS. At this time, the CINR is used as CQI and is expressed by using a predetermined number of bits (e.g. five bits). The feedback of the CINR value for each of the multiple (e.g. five) bands results in overhead to the entire system.

Therefore, the present invention provides a new CQI feedback scheme for feedingback the CINR values of the five bands by using a smaller number of bits. According to the CQI feedback scheme of the present invention, instead of using five bits for each of the feedback CINR of the five bands, only one CINR value corresponding to a central value among the CINR values of the five bands (central CINR value) is expressed by five bits, and each of the differences between the central CINR value and the CINR values of the other four bands is expressed by a predetermined number of bits (e.g. four bits) in the feedback CQI. Hereinafter, for convenience of description, the CQI feedback scheme for feedingback the five bit CINR value for each of the five bands will be referred to as “the first CQI feedback scheme,” and the CQI feedback scheme for feedingback a central CINR value expressed by five bits and differences between the central CINR value and the CINR values of the other four bands, each of which is expressed by four bits, will be referred to as “the second CQI feedback scheme.”

In the case of using the second CQI feedback scheme, the total number of bits necessary for transmission of the CINR values of the five bands is reduced to 21 (=5+4×4) from 25 (=5×5) in the case of using the first CQI feedback scheme, thereby reducing system overhead.

Meanwhile, when information data to be transmitted occupies K bits, the information data is usually encoded by using a coding scheme in order to prevent the occurrence of error due to noise or interference, etc. When the information data is coded by using a coding scheme, the number of finally transmitted coded bits is N. In this case, the coding rate R can be defined by Equation (1) below.

$$R = \frac{K}{N} \qquad ( 1 )$$

For example, when the number of bits of the information data to be transmitted is 25, the number of actually transmitted coded bits is

$$\frac{25}{R} .$$

When the number of bits of the information data to be transmitted is 21, the number of actually transmitted coded bits is

$$\frac{21}{R} .$$

However, when the control data, such as the CQI, has an error, system performance is significantly degraded. Therefore, in order to secure the reliability of the control data, a lower coding rate is usually used for the control data rather than for information data. For example, in the case where the coding rate R is ⅙

$$( R = \frac{1}{6} ) ,$$

the number of CQI bits to be transmitted is 150 (25/R=150) when the CINR value is transmitted according to the first CQI feedback scheme and is 126 (21/R=126) when the CINR value is transmitted according to the second CQI feedback scheme. Therefore, the difference between the numbers of actually transmitted coded bits is larger than the difference between the numbers of information bits, that is, the difference between the numbers of bits indicating the CINR values. Therefore, it can be said that the second CQI feedback scheme for feedingback a central CINR value expressed by five bits and differences between the central CINR value and the CINR values of the other four bands, each of which is expressed by four bits, is more effective than the first CQI feedback scheme for feedingback the five bit CINR value for each of the five bands.

However, when the second CQI feedback scheme is used and the five bits for expressing the central CINR value has an error, it is impossible to detect an exact central CINR value, and the incorrect central CINR value makes it impossible to use the differences between the other CINR values and the central CINR value even when the other CINR values have no error. This not only degrades the entire system performance but also increases the system overhead because it is necessary to feedback the CQI again. Therefore, the present invention provides third to fifth feedback schemes which can minimize the system overhead and prevent the occurrence of error, thereby ensuring the reliability. Hereinafter, the third to fifth feedback schemes according to the present invention will be described.

First, in order to prevent an error from occurring in the central CINR value, it is necessary to encode the bits expressing the central CINR value by using a coding rate as low as possible. At this time, the coding rate for coding the bits for the central CINR value must be determined in consideration of the number of all transmitted coded bits and a target Bit Error Rate (BER).

It is assumed that the number of all transmitted coded bits is 21/R and the target BER is P. Here, the target BER P is influenced by the coding rate R, and there is a positive correlation between the target BER P and the coding rate R, that is, the larger the target BER P, the larger the coding rate R. Further, it is assumed that the coding rate and the target BER applied in order to encode the central CINR value of five bits are R₁ and P₁, respectively, and the coding rate and the target BER applied in order to encode the differences between the central CINR value and the other CINR values are R₂ and P₂, respectively. The coding rate R₁ must satisfy the first condition and the second condition as follows.
1^{st} Condition

$$\frac{5}{{R}_{1}} + \frac{16}{{R}_{2}} \leq \frac{21}{R}$$

2^{nd} Condition
P₂≦P

The coding rate R₁ is always smaller than the coding rate R₂, the target BER P₁ is also always smaller than the target BER P₂. Therefore, by satisfying only the second condition, it is possible to transmit the coded bits in accordance with a corresponding target BER.

Based on the first condition and the second condition, it is possible to consider the following two schemes, that is, the third CQI feedback scheme and the fourth CQI feedback scheme.

According to the third CQI feedback scheme, the coding rate R₂ is increased, and the coding rate R₁ is reduced according to the number of coded bits decreasing due to the increase of the coding rate R₂, under an assumption that the number of transmitted coded bits is maintained constant at 21/R. Here, the increase of the coding rate R₂ is allowed only within a range which can satisfy the second condition. When the coding rate R₁ is reduced, the five bits for the central CINR value are encoded by a low coding rate, so that they can be reliably transmitted.

According to the fourth CQI feedback scheme, the coding rate R₁ is reduced and the coding rate R₂ is increased, while satisfying the first condition,

$$\frac{5}{{R}_{1}} + \frac{16}{{R}_{2}} \leq \frac{21}{R} .$$

When the second scheme is used, it is possible to transmit a smaller number of coded bits. In this case, the reduction of the coding rate R₁ by the second scheme is less than that by the first scheme, so that the reliability of the five bits for expressing the central CINR value may degrade. However, in this case also, the coding rate R₁ has a value which is always smaller than the coding rate R in the case of using the first CQI feedback scheme. Therefore, the second scheme has a high reliability and can decrease the number of transmitted coded bits. Of course, the second condition must be considered in increasing the coding rate R₂ in the second scheme also.

According to channel state, a situation which does not satisfy the first condition and satisfies only the second condition may occur. In this situation, it is possible to increase the coding rate R₂ and decrease R₁ within a range which does not satisfy the first condition but satisfies the third condition as follows.
3^{rd} Condition

$$\frac{5}{{R}_{1}} + \frac{16}{{R}_{2}} \leq \frac{25}{R}$$

According to the third scheme which satisfies the second condition and the third condition, that is, the fifth CQI feedback scheme, the number of entire transmitted encoded bits is larger than that in the third CQI feedback scheme or the fourth CQI feedback scheme. However, the number of entire transmitted encoded bits according to the fifth CQI feedback scheme is smaller than the number of entire transmitted encoded bits according to the first CQI feedback scheme. Therefore, it is possible to reliably transmit the central CINR value by the fifth CQI feedback scheme.

Further, according to the present invention, the CQI generated according to one of the third to fifth CQI feedback schemes, which include the central CINR and difference thereof, is demultiplexed into structured block LDPC codes, so that it is possible to achieve more reliable CQI transmission/reception using the characteristic of the structured block LDPC codes; that is, performance improvement according to an increase in the number of information data bits.

After the CQI transmission system determines the coding rates R₁ and R₂, it is sometimes necessary to report the determined coding rates R₁ and R₂ to the CQI reception system. That is, although it is unnecessary to report the determined coding rates R₁ and R₂ to the CQI reception system when the coding rates R₁ and R₂ have fixed values, the CQI transmission system must report the determined coding rates R₁ and R₂ to the CQI reception system without fail when the coding rates R₁ and R₂ have variable values. Here, a base station serves as the CQI reception system and a mobile station serves as the CQI transmission system. The operation of reporting the coding rates R₁ and R₂ to the CQI reception system itself has no relation to the present invention, so description thereof will be omitted here.

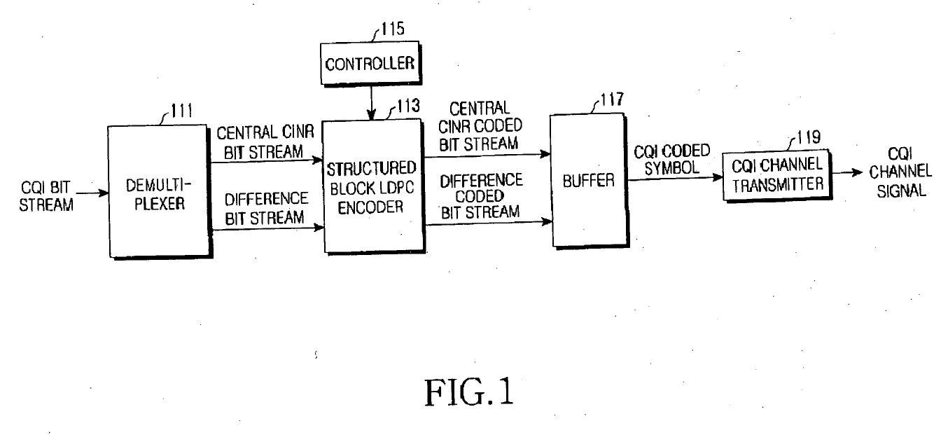

Hereinafter, a structure of a CQI transmission system according to the present invention will be described with reference to the block diagram of FIG. 1, which schematically illustrates the structure of a CQI transmission system.

Referring to FIG. 1, the CQI transmission system includes a demultiplexer (DEMUX) 111, a structured block LDPC encoder 113, a controller 115, a buffer 117, and a CQI channel transmitter 119.

First, when a CQI bit stream to be transmitted is present in the CQI transmission system, the CQI bit stream is transferred to the demultiplexer 111. The CQI bit stream is a bit stream totaling 21 bits, which includes a central CINR value of five selected bands, which have the highest and sequentially next highest CINR values, and differences between the central CINR value and the other CINR values. The demultiplexer 111 demultiplexes the received CQI bit stream into a bit stream for expressing the central CINR value (central CINR bit stream) and a bit stream for expressing the differences (difference bit stream), and then outputs the demultiplexed bit stream to the structured block LDPC encoder 113. The reason why the demultiplexer 111 demultiplexes the CQI bit stream into the central CINR bit stream and the difference bit stream is that the coding rates R₁ and R₂ applied to the central CINR bit stream and the difference bit stream are different from each other.

The structured block LDPC encoder 113 encodes the central CINR bit stream and the difference bit stream into structured block LDPC codes according to coding rates determined under the control of the controller 115, and then outputs the generated LDPC codes to the buffer 117. Specifically, the structured block LDPC encoder 113 encodes the central CINR bit stream into structured block LDPC codes according to the coding rate R₁ and the difference bit stream into structured block LDPC codes according to the coding rate R₂, and then outputs the generated LDPC codes to the buffer 117. The controller 115 determines the coding rate R₁ for the central CINR bit stream and the coding rate R₂ for the difference bit stream, outputs the determined coding rate R₁ and R₂ to the structured block LDPC encoder 113, and controls the structured block LDPC encoder 113 to encode the central CINR bit stream into structured block LDPC codes according to the coding rate R₁ and the difference bit stream into structured block LDPC codes according to the coding rate R₂. The operation of generating structured block LDPC codes by applying coding rates, i.e. variable coding rates, to input signals by the block LDPC encoder 113 will be described in more detail below. The structured block LDPC codes generated by encoding the central CINR bit stream with the coding rate R₁ become a central CINR coded bit stream and the structured block LDPC codes generated by encoding the difference bit stream with the coding rate R₂ become a difference coded bit stream.

The buffer 117 buffers the central CINR coded bit stream and the difference coded bit stream output from the structured block LDPC encoder 113, which have been encoded from the central CINR bit stream and the difference bit stream, respectively, generates a CQI coded symbol by concatenating the central CINR coded bit stream and the difference coded bit stream, and then outputs the generated CQI coded symbol to the CQI channel transmitter 119. The CQI channel transmitter 119 generates a CQI channel signal by processing the CQI coded symbol input from the buffer 117 in accordance with the CQI channel format of the CQI transmission system, and then transmits the generated CQI channel signal to a CQI reception system.

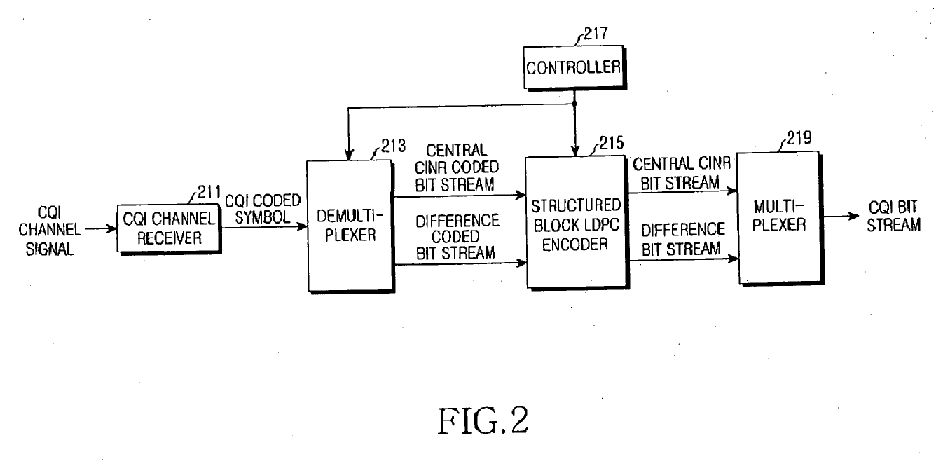

Hereinafter, a structure of a CQI reception system according to the present invention will be described with reference to the block diagram of FIG. 2, which schematically illustrates the structure of a CQI reception system.

Referring to FIG. 2, the CQI reception system includes a CQI channel receiver 211, a demultiplexer 213, a structured block LDPC decoder 215, a controller 217, and a multiplexer 219.

The CQI channel signal transmitted from the CQI transmission system as shown in FIG. 1 is received by the CQI channel receiver 211 which generates a CQI coded symbol by channel-processing the received CQI channel signal and then outputs the generated CQI coded symbol to the demultiplexer 213. The demultiplexer 213 demultiplexes the CQI coded symbol from the CQI channel receiver 211 into a central CINR coded bit stream and a difference coded bit stream under the control of the controller 217 and outputs the demultiplexed streams to the structured block LDPC decoder 215. The controller 217 provides the same coding rates as those applied to the central CINR bit stream and the difference bit stream in the CQI transmission system, in order to demultiplex the CQI coded symbol from the CQI channel receiver 211 into a central CINR coded bit stream and a difference coded bit stream. In other words, the controller 217 preliminarily recognizes the same coding rates as those applied to the central CINR bit stream and the difference bit stream in the CQI transmission system, and provides the same coding rates as those applied to the central CINR bit stream and the difference bit stream in the CQI transmission system to the demultiplexer 213, so that the demultiplexer 213 can demultiplex the CQI coded symbol from the CQI channel receiver 211 into a central CINR coded bit stream and a difference coded bit stream.

Under the control of the controller 217, the structured block LDPC decoder 215 generates a central CINR bit stream and a difference bit stream by decoding the central CINR coded bit stream and the difference coded bit stream from the demultiplexer 213 according to the same coding rates as those applied in the CQI transmission system, and then outputs the generated central CINR bit stream and difference bit stream to the multiplexer 219. The operation of the structured block LDPC decoder 215 will be described in more detail below. The multiplexer 219 generates and outputs a CQI bit stream by multiplexing the signals output from the structured block LDPC decoder 215.

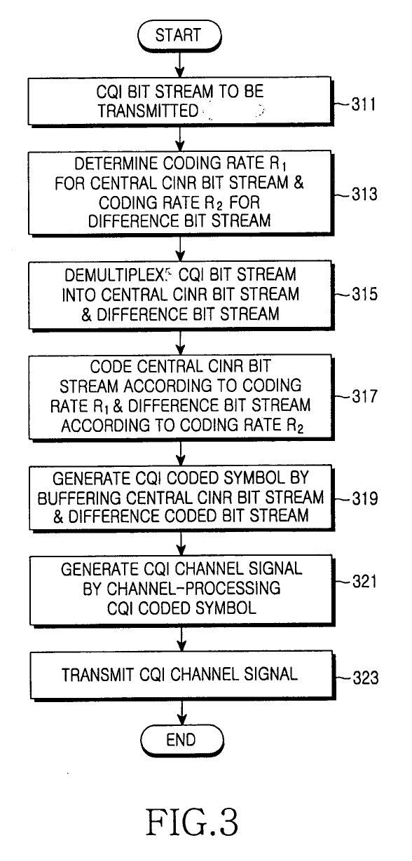

Hereinafter, a process for CQI transmission according to the present invention will be described with reference to the flowchart of FIG. 3.

Referring to FIG. 3, first, when a CQI bit stream to be transmitted is present in step 311, the CQI transmission system proceeds to step 313. In step 313, the CQI transmission system determines the coding rate R₁ for the central CINR bit stream and the coding rate R₂ for the difference bit stream. Then, in step 315, the CQI transmission system demultiplexes the CQI bit stream into the central CINR bit stream and the difference bit stream.

In step 317, the CQI transmission system generates the central CINR coded bit stream including structured LDPC codes by encoding the central CINR bit stream according to the coding rate R₁ and generates the difference coded bit stream including structured LDPC codes by encoding the difference bit stream according to the coding rate R₂. In step 319, the CQI transmission system generates a CQI coded symbol by buffering the central CINR bit stream and the difference coded bit stream. In step 321, the CQI transmission system generates a CQI channel signal by channel-processing the CQI coded symbol. Finally, in step 323, the CQI transmission system transmits the CQI channel signal to the CQI reception system.

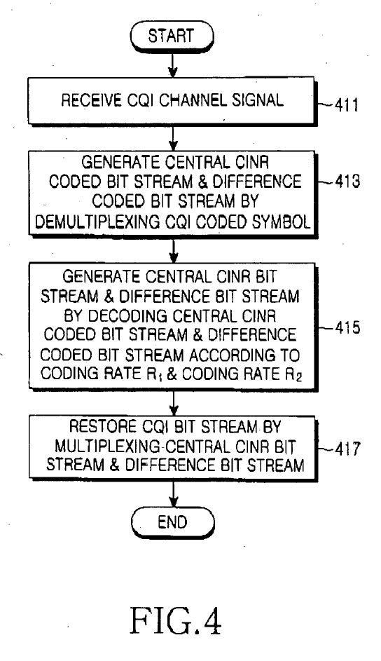

Hereinafter, a process for CQI reception according to the present invention will be described with reference to the flowchart of FIG. 4.

Referring to FIG. 4, in step 411, the CQI reception system receives a CQI channel signal and generates a CQI coded symbol by channel-processing the received CQI channel signal. In step 413, the CQI reception system generates a central CINR coded bit stream and a difference coded bit stream by demultiplexing the CQI coded symbol.

In step 415, the CQI reception system generates a central CINR bit stream and a difference bit stream by decoding the central CINR coded bit stream and the difference coded bit stream in accordance with corresponding coding rates applied in the CQI transmission system, that is, by decoding the central CINR coded bit stream according to the coding rate R₁ and the difference coded bit stream according to the coding rate R₂. In step 417, the CQI reception system restores a CQI bit stream by multiplexing the central CINR bit stream and the difference bit stream.

Hereinafter, the operation of the structured block LDPC encoder 113 will be described.

It is generally known that the LDPC code together with a turbo code has a good performance gain during high speed transmission and can effectively correct errors due to noise occurring in the transmission channel, thereby improving reliability in data transmission. However, the LDPC code is disadvantageous in view of the coding rate. That is, the LDPC code has a relatively high coding rate and is thus relatively restricted by the coding rate. Most LDPC codes proposed up to date have a coding rate of ½ and only some of them have a coding rate of ⅓. Such a restriction in the coding rate may have a fatal influence on large volume data transmission at a high speed. Of course, in order to implement a low coding rate, it is possible to obtain a degree distribution, which shows an optimum performance, using, for example, a density evolution scheme. However, it is still difficult to implement an LDPC code having a degree distribution which shows an optimum performance, due to various restrictive elements, such as a cycle structure in the factor graph, difficulty in hardware implementation, etc.

However, in order to transmit the CQI as described above, it is necessary to support various coding rates. However, as described above, in the case of LDPC code, it is difficult to support various coding rates. Further, in order to transmit the CQI, it is necessary to be able to construct a code which supports various coding rates using one encoder.

Design of a structured block LDPC code which supports various coding rates, that is, variable coding rates as described above, is achieved by design of a parity check matrix, as is a typical LDPC code. However, in order to provide a structured block LDPC code which supports a variable coding rate by one CODEC in a mobile communication system, that is, in order to provide a structured block LDPC code which supports various coding rates, the parity check matrix must include another parity check matrix for expressing a block LDPC code supporting another coding rate. That is to say, it is necessary to be able to support two or more coding rates using one parity check matrix. Representative schemes for supporting two or more coding rates using one parity check matrix include a shortening scheme, an elimination scheme, and a puncturing scheme, which will be described hereinafter.

First, the shortening scheme will be described.

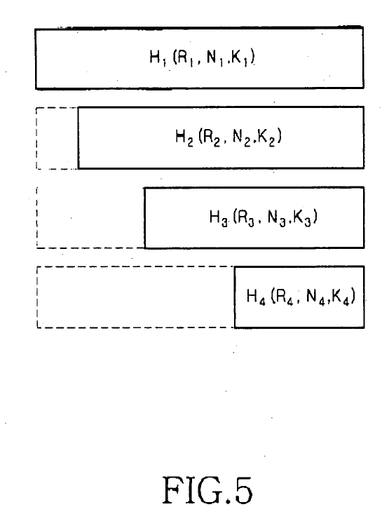

According to the shortening scheme, the coding rate is decreased by gradually reducing the number of columns of a parity check matrix, which correspond to information words, while fixing the number of rows of the parity check matrix. The shortening scheme is useful in order to acquire various coding rates for various codeword lengths. Hereinafter, a process for generating a parity check matrix of structured block LDPC codes using the shortening scheme will be described with reference to FIG. 5.

FIG. 5 is a view schematically illustrating a process for generating a parity check matrix of structured block LDPC codes using a shortening scheme according to the present invention.

Referring to FIG. 5, Hᵢ(Rᵢ,Nᵢ,Kᵢ) denotes a parity check matrix having a coding rate of Rᵢ, a codeword length of Nᵢ, and an information word length of Kᵢ, wherein Nᵢ>Nⱼ and Kᵢ>Kⱼ, when i<j. The process of changing from structured block LDPC codes generated in accordance with the parity check matrix of H₁(R₁,N₁,K₁) ((R₁,N₁,K₁)-structured block LDPC codes) to structured block LDPC codes generated in accordance with the parity check matrix of H₂(R₂,N₂,K₂) ((R₂,N₂,K₂)-structured block LDPC codes) can be easily understood assuming that (K₁-K₂) number of first information word bits of the (R₁,N₁,K₁)-structured block LDPC codes are all fixed to 0. Further, the (Rᵢ,Nᵢ,Kᵢ)-structured block LDPC codes other than the (R₂,N₂,K₂)-structured block LDPC codes can also be easily generated by fixing (K₁-Kᵢ) number of information word bits of the (R₁,N₁,K₁)-structured block LDPC codes to 0.

Therefore, in the process of generating a parity check matrix using the shortening scheme as described above with reference to FIG. 5, a coding rate of a corresponding structured block LDPC code is defined by Equation (2) below.

$${R}_{1} = \frac{{K}_{1}}{{N}_{1}} , {R}_{i} = \frac{{K}_{i}}{{N}_{i}} = \frac{{K}_{1} - ( {K}_{1} - {K}_{i} )}{{N}_{1} - ( {K}_{1} - {K}_{i} )} \qquad ( 2 )$$

When i<j, Equation (2) can be expressed as Equation (3) below.

$$\begin{matrix}{R}_{i} - {R}_{j} = \frac{{K}_{1} - ( {K}_{1} - {K}_{i} )}{{N}_{1} - ( {K}_{1} - {K}_{i} )} - \frac{{K}_{1} - ( {K}_{1} - {K}_{j} )}{{N}_{1} - ( {K}_{1} - {K}_{j} )} \\ = \frac{( {N}_{1} - {K}_{1} ) ( {K}_{i} - {K}_{j} )}{( {N}_{1} - ( {K}_{1} - {K}_{i} ) ) ( {N}_{1} - ( {K}_{1} - {K}_{j} ) )} \\ > 0\end{matrix} \qquad ( 3 )$$

As noted from Equation (3), the coding rate is reduced when the parity check matrix is generated by using the shortening scheme.

Further, on an assumption that the parity check matrix H₁(R₁,N₁,K₁) has the full rank in FIG. 5, even though the parity check matrix is generated using the shortening scheme, the number of rows of the parity check matrix generated using the shortening scheme is maintained constant, so that the parity length is maintained the same while the information word length is shortened. Thus, it is noted that the coding rate is reduced. In general, when columns corresponding to parities are eliminated from a predetermined parity check matrix, a codeword set, which is totally different from a codeword set generated when the columns corresponding to parities are not eliminated, is generated. Therefore, the shortening scheme is based on a principle of eliminating columns corresponding to the information words.

Second, the elimination scheme will be described.

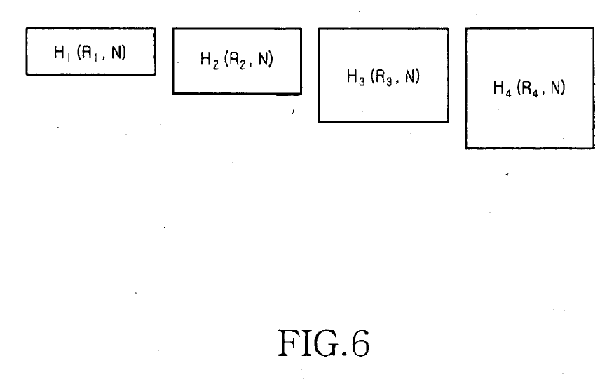

According to the elimination scheme, the coding rate is reduced by increasing the number of rows of the parity check matrix while fixing the number of columns of the parity check matrix. The increase in the number of columns of the parity check matrix refers to an increase in the number of check equations which must be satisfied by the code words. When the number of check equations increases, the number of code words satisfying the check equations decreases. Therefore, code words which cannot satisfy check equations added according to the increase in the number of rows of the parity check matrix are eliminated from an existing codeword set in the elimination scheme, and the elimination scheme is given its name due to such a process. Hereinafter, a process for generating a parity check matrix of structured block LDPC codes using the elimination scheme will be described with reference to FIG. 6.

FIG. 6 is a view schematically illustrating a process for generating a parity check matrix of structured block LDPC codes using an elimination scheme according to the present invention.

Referring to FIG. 6, Hᵢ(Rᵢ,N) denotes a parity check matrix having a coding rate of Rᵢ and a codeword length of Nᵢ. Assuming that each of the parity check matrixes shown in FIG. 6 has the full rank Mᵢ, a coding rate of a structured block LDPC code generated in accordance with each of the parity check matrixes can be expressed by Equation (4) below.

$${R}_{i} = \frac{N - {M}_{i}}{N} = 1 - \frac{{M}_{i}}{N} \qquad ( 4 )$$

As noted from Equation (4), for i, the full rank Mᵢ increases, and thus the coding rate Rᵢ decreases. Of course, it is possible to generate a parity check matrix having a high coding rate by eliminating the rows based on the parity check matrix having a very low coding rate like H₄(R₄,N) as shown in FIG. 6.

Third, the puncturing scheme will be described.

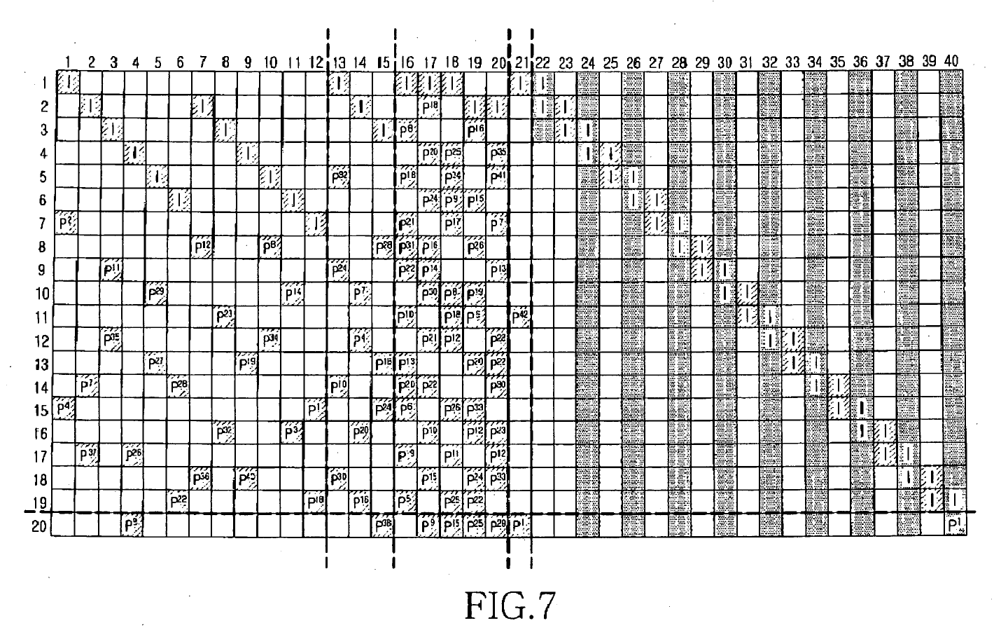

According to the puncturing scheme, the coding rate is increased by transmitting a part of the parities generated by an encoder, instead of transmitting all the generated parities as in the case of using a turbo code. The puncturing scheme is different from the shortening scheme or the elimination scheme in which rows or columns of the parity check matrix are eliminated or added, because the parity check matrix can be considered to actually have no change although all of the generated parities are not transmitted. Hereinafter, a process for generating a parity check matrix of structured block LDPC codes using the puncturing scheme will be described with reference to FIG. 7.

FIG. 7 is a view schematically illustrating a process for generating a parity check matrix of structured block LDPC codes using a puncturing scheme according to the present invention.

The matrix shown in FIG. 7 is a parity check matrix of structured block LDPC codes, which has a coding rate of ½ and a size of (N,K)=(1720,860). The parity check matrix includes (20×40) number of partial blocks, and a partial matrix corresponding to each of the partial blocks is a square matrix having a size of Nₛ×Nₛ, that is, 43×43.

If code words of a structured block LDPC code are classified into information words and parities, the information words and the parities can also be considered on a block unit basis. Therefore, a codeword of a structured block LDPC code can be defined by Equation (5) below.
c=(u₁,u₂, . . . , u₂₀p₁, p₂, . . . , p₂₀) (5)

In Equation (5), uᵢ and pᵢ denote a row vector having a size of 1×43.

If blocks at turns of even numbers in a parity part corresponding to the parities in the parity check matrix as shown in FIG. 7 are punctured, a codeword of a structured block LDPC code according to the puncturing can be defined by Equation (6) below.
c_{punc}=(u₁, u₂, . . . , u₂₀p₁, p₃, p₅, . . . , p₁₇, p₁₉) (6)

In Equation (6), c_{punc} denotes a codeword of a structured block LDPC code according to the puncturing. The codeword as defined in Equation (6) results is the same as the codeword of the structured block LDPC code having a coding rate of ⅔. That is, when the puncturing scheme is used, the length of the information word is maintained the same although the coding rate changes.

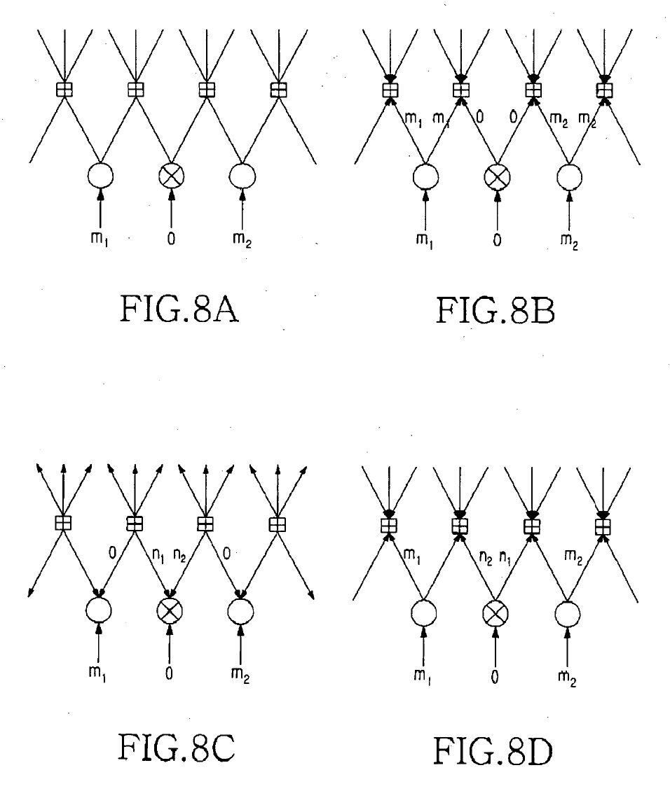

When the codeword of the structured block LDPC code generated by the puncturing is decoded, the original parity check matrix is used as it is by erasing the punctured parity bits. That is to say, if the Log-Likelihood Ratio (LLR) value input from a channel for transmitting the punctured parity bits is considered to be always 0, it is possible to use the original parity check matrix as it is for the decoding. Therefore, a node corresponding to the punctured parity has no influence at all on performance improvement or performance degradation according to iterative decoding during the process of decoding and simply serves as a path for passage of messages transferred from other nodes. Hereinafter, the function of a node corresponding to a parity punctured according to the puncturing scheme during the decoding of the codeword of the structured block LDPC code generated by the puncturing scheme will be described with reference to FIGS. 8A through 8D.

In FIGS. 8A through 8D, \textcircled{x} denotes a node corresponding to the punctured parity, and the arrows indicate directions in which the message is actually transferred. First, from FIG. 8A, it is noted that an LLR value of “0” is input to the node corresponding to the punctured parity. Then, the messages input from the channel shown in FIG. 8A are transferred to check nodes during the first decoding as shown in FIG. 8B. In FIG. 8B, each of the variable nodes transfers the input message, i.e. a symbol probability value, to check nodes connected to the variable node. At this time, the node corresponding to the parity transfers the LLR value of “0” to the connected check nodes.

Then, the check nodes calculate new probability values by performing a predetermined operation using the probability values input from the variable nodes connected to the check nodes, and then transfer the calculated new probability values to the variable nodes. At this time, the messages transferred to all the nodes connected to the node corresponding to the punctured parity from the check node become “0” as shown in FIG. 8C. Further, the message transferred to the node corresponding to the punctured parity is not “0,” and the messages transferred to the nodes corresponding to the punctured parities are transferred through their own paths without influencing to each other as shown in FIG. 8D. The decoding process thereafter is the same as that of a typical structured block LDPC code, and the node corresponding to the punctured parity continuously serves as a simple message transfer path without having an influence on the performance improvement according to decoding.

As described above, using the puncturing scheme, it is possible to use the original encoder and decoder as they are for encoding and decoding. That is, according to the puncturing scheme, the encoding complexity and the decoding complexity are nearly constant regardless of the coding rate and the length of the block (codeword). Further, according to the puncturing scheme, the coding rate is changed by changing only the length of the parity while fixing the length of the information word. Therefore, the puncturing scheme has a high reliability. The structured block LDPC codes generated using the puncturing scheme may have different performances according to the puncturing patterns. Therefore, design of the puncturing pattern has an important effect on the structured block LDPC codes.

Next, a method for generating actual structured block LDPC codes by using the shortening scheme and the puncturing scheme will be described in detail. The coding rate of the structured block LDPC codes can be changed by using the shortening scheme, as is that of typical block codes. Therefore, the present invention uses the shortening scheme for changing the coding rate of the structured block LDPC codes.

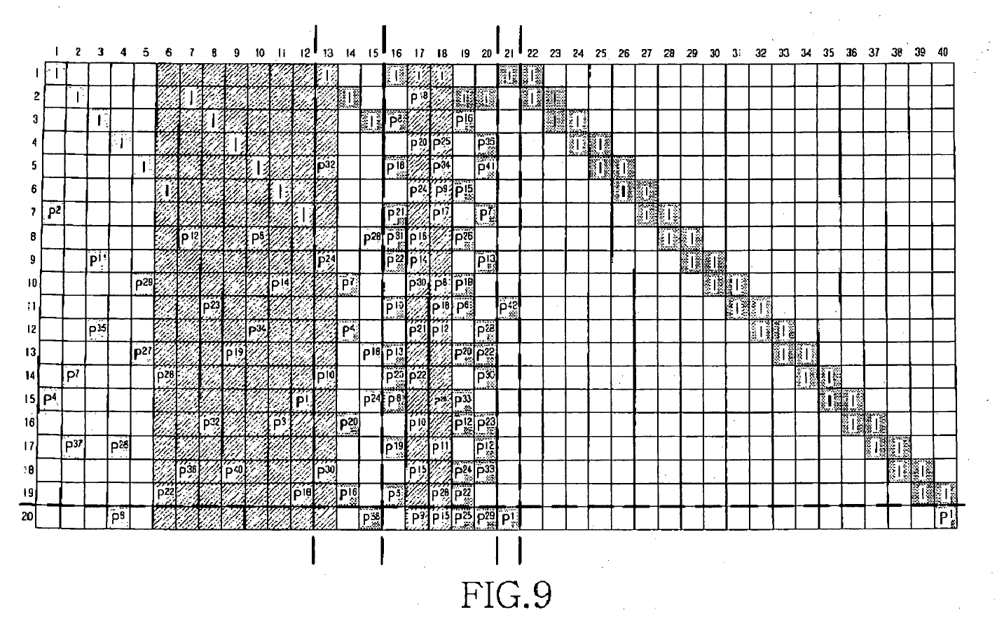

Hereinafter, a process for generating a parity check matrix of structured block LDPC codes using the shortening scheme will be described with reference to FIG. 9.

FIG. 9 is a view for schematically illustrating a process for generating a parity check matrix of structured block LDPC codes using a shortening scheme according to the present invention.

The matrix shown in FIG. 9 can be generated by considering all of u₆, u₇, . . . , u₁₃, u₁₇, u₁₈ of the codeword c of the structured block LDPC codes corresponding to the parity check matrix shown in FIG. 7 as 0. The shortening scheme has the same effect as the case of eliminating a part of the information word from the parity check matrix, and is thus different from the puncturing scheme. That is, the parity check matrix generated using the shortening scheme has coding rates and a degree distribution which are completely different from those of the originally given parity check matrix. Therefore, it is necessary to select the columns to be eliminated from the originally given parity check matrix, in consideration of the degree distribution of the parity check matrix generated using the shortening scheme. To this end, both the parent parity check matrix, which is the initially given parity check matrix before the shortening scheme is used, and the children parity check matrix, which is the parity check matrix after the shortening scheme is used, must be generated to have optimized degree distributions.

In general, under a condition of finite length, a check node has a higher average degree in a structured block LDPC code of a high coding rate showing good performance than in a structured block LDPC code of a low coding rate showing good performance. Therefore, in order to generate a structured block LDPC code of a low coding rate using the shortening scheme, it is necessary to have a structure for reducing the average degree of the check node after using the shortening scheme. In addition, the degree distribution is changed by the use of the shortening scheme. Therefore, in order to design structured block LDPC codes of various coding rates having a good noise threshold value using the density evolution scheme, it is necessary to simultaneously consider both the degree distribution of the parent parity check matrix and the degree distribution of the children parity check matrix generated by the shortening scheme. However, using the puncturing scheme which considers the punctured variable nodes as erased nodes without actually eliminating them, it is possible to generate structured block LDPC codes of a high coding rate without causing change in the general degree distribution of the parity check matrix.

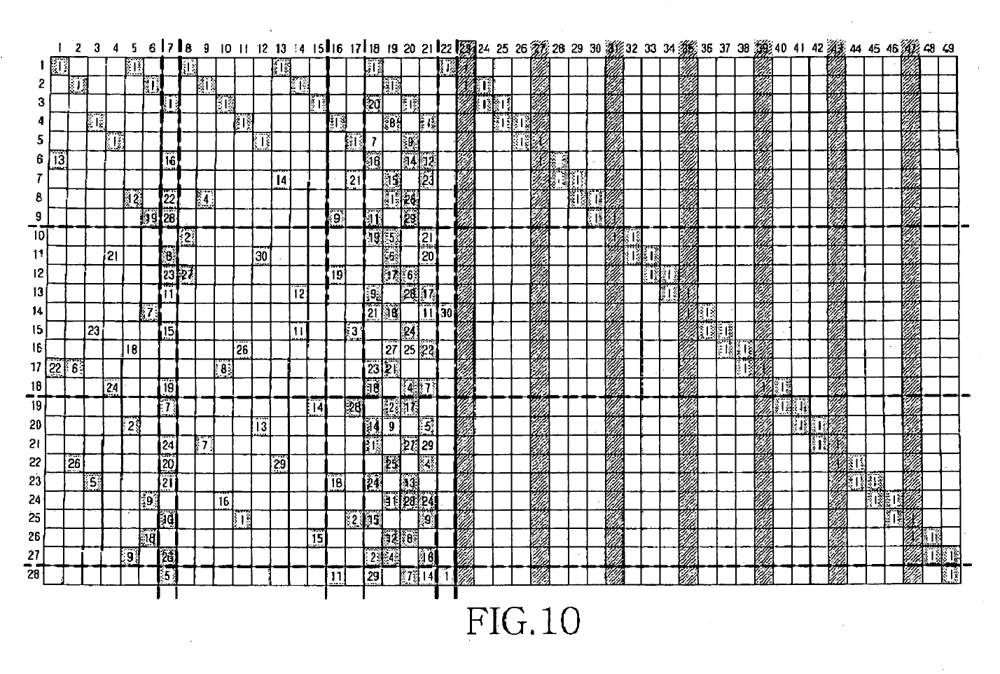

Next, a process for generating structured block LDPC codes capable of supporting various coding rates, i.e. a variable coding rate, by one parity check matrix (a one parent parity check matrix) will be described. The following description discusses an example of structured block LDPC codes, which has a fixed codeword length and a variable coding rate. Further, the following description with reference to FIG. 10 discusses a method for generating a structured block LDPC code, which is an example of structured block LDPC codes having various coding rates and a fixed codeword length and has a coding rate changeable from ⅓ to ½ using the shortening scheme and the puncturing scheme, wherein a parent parity check matrix and a children parity check matrix generated from the parent parity check matrix by the shortening scheme have good noise threshold values.

FIG. 10 is a view for illustrating a parity check matrix of structured block LDPC codes supporting variable coding rates according to the present invention.

The parity check matrix shown in FIG. 10 includes 49 partial block columns and 28 partial block rows, and each of the partial blocks in the parity check matrix corresponds to a partial matrix having a size of Nₛ×Nₓ. The partial matrix refers to a permutation matrix corresponding to each partial block. Further, if it is said that a partial matrix has a size of Nₛ, it implies that the partial matrix is a square matrix having a size of Nₛ×Nₛ and it is only a shortened expression for convenience of description. That is, it should be noted that the size of the partial matrix can be expressed by either of Nₛ or of Nₛ×Nₛ. Meanwhile, the coding rate of the parity check matrix shown in FIG. 10 can be defined by Equation (7) below.

$$R = \frac{49 - 28}{49} = \frac{21}{49} = \frac{3}{7} \qquad ( 7 )$$

That is, although the parity check matrix shown in FIG. 10 is used for structured block LDPC codes having a coding rate of 3/7 and a codeword length of 49Nₛ, it is possible to generate a parity check matrix of structured block LDPC codes which can support variable coding rates by a single parity check matrix, using the shortening scheme and the puncturing scheme. For example, it is possible to generate structured block LDPC codes having a coding rate of ⅓ and a codeword length of of 42Nₛ by shortening the first to seventh block columns using the shortening scheme, mapping the partial matrixes corresponding to the eighth to the 21^{st} partial block columns to information words, and then mapping the partial matrixes corresponding to the 22^{nd} to the 49^{th} partial block columns to parities.

For another example, it is possible to generate structured block LDPC codes having a coding rate of ½ and a codeword length of 42Nₛ by mapping the partial matrixes corresponding to the first to the 21^{st} partial block columns to information words and then puncturing seven partial block columns from among the 22^{nd} to the 49^{th} partial block columns using the puncturing scheme. As noted from these examples, using the shortening scheme or puncturing scheme, it is possible to generate structured block LDPC codes having different coding rates even with the same codeword length.

Meanwhile, the most important factor in generating the structured block LDPC codes supporting variable coding rates is to design not only the parent parity check matrix but also the children parity check matrix to have good performance in view of the noise threshold value. Therefore, a parity check matrix of structured block LDPC codes having a low coding rate is generated to have an optimized degree distribution, and a parity check matrix of structured block LDPC codes having a high coding rate is generated to have an optimized degree distribution and include the optimized parity check matrix of the low coding rate.

That is, the parity check matrix shown in FIG. 10 is generated by optimizing the degree distribution for a parity check matrix of structured block LDPC codes having a coding rate of ⅓ and then optimizing the degree distribution for a parity check matrix of structured block LDPC codes having a coding rate of 3/7 and including the optimized parity check matrix. In the parity check matrix shown in FIG. 10, for convenience in design of the parity check matrix, the degrees of the variable nodes are limited to four types including degrees of 2, 3, 5, and 16, and the degrees of the check nodes are limited to three types including degrees of 5, 6, and 7.

In the parity check matrix shown in FIG. 10, the structured block LDPC codes having a coding rate of ⅓ have a noise threshold of σ*=1.256 (−0.219 dB), and the structured block LDPC codes having a coding rate of 3/7 have a noise threshold of σ*=1.066 (−0.114 dB). The parity check matrix has degree distributions as follows (Shannon limits are −0.495 dB and −0.122 dB, respectively).

Degree distribution of the structured block LDPC codes having a coding rate of ⅓:

λ₂=0.348, λ₃=0.174, λ₅=0.065, λ₁₆=0.413; and

ρ₅=0.419, ρ₆=0.581.

Degree distribution of the structured block LDPC codes having a coding rate of 3/7:

λ₂=0.280, λ₃=0.202, λ₅=0.104, λ₁₆=0.414; and

ρ₆=0.093.

In the above relations, λᵢ(i=2, 3, 5, 16) denotes distribution of edges related to a variable node having a degree of i, and ρᵢ denotes distribution of edges related to a check node having a degree of i.

In other words, in order to support variable coding rates, a parity check matrix of the structured block LDPC codes having a low coding rate is first optimized, a result of the optimization is set as one constraint, and optimization is then sequentially performed for the case of a high coding rate based on the constraint, so as to design a noise threshold of good performance for each coding rate. Further, although the types of the degrees of the variable nodes are limited to four types in the parity check matrix shown in FIG. 10 for convenience of description, it is possible to acquire a noise threshold of a better performance by allowing a wider variety of degrees for the variable nodes.

Hereinafter, a process for designing structured block LDPC codes having variable coding rates on condition that the number of check nodes is limited to M, the maximum degree of the variable node is limited to d_{v,max}, the coding rates are R₁, R₂, . . . , Rₘ (R₁<R₂< . . . <Rₘ), and each parity check matrix has a size of M×Nᵢ will be described.

1^{st} Stage

First, optimization of degree distribution is performed using density evolution for the case where the coding rate is R₁. It is assumed that a ratio of variable nodes having a degree of j (1≦j≦d_{v,max}) to the entire variable nodes is f_{1,j} in the degree distribution obtained as a result of the optimization. The ratio f_{1,j} and the degree distribution λ_{1,j} of edges can be changed with each other using the relation as defined by Equation (8) below, wherein λ_{1,j} denotes a ratio of edges connected to the variable nodes having a degree of j (1≦j≦d_{v,max}) to the entire edges.

$$\begin{matrix}{f}_{1 , j} = \frac{{λ}_{1 , j} / j}{{\sum }_{k} {λ}_{1 , k} / k} & ← \to & {λ}_{1 , j} = \frac{j \cdot {f}_{1 , j}}{{\sum }_{k} k \cdot {f}_{1 , k}}\end{matrix} \qquad ( 8 )$$

In Equation (8), k has the same value as the degree j, and the check nodes are considered in the same manner as that for the variable node.

2^{nd} Stage

For l (2≦l≦m), the degree distribution obtained through the first stage is optimized again based on an additional condition that total N₁ (the codeword length of Rᵢ) number of variable nodes include (f_{l-Ij}×Nₗ₋₁) number of variable nodes having a degree of j. The check nodes are considered in the same manner as that for the variable node.

By performing the optimization of degree distribution in the manner as described in the first and second stages, it is possible to design a parity check matrix of the structured block LDPC codes supporting various coding rates. Further, it is noted that the designed parity check matrix is a parity check matrix corresponding to structured block LDPC codes which have a fixed parity length of M and a variable block length of Nᵢ by the shortening scheme in accordance with the coding rate Rᵢ. Further, using the puncturing scheme together with the shortening scheme, it is possible to generate structured block LDPC codes having a wider variety of coding rates and block (codeword) lengths.

Meanwhile, assuming that the number of punctured bits is Pᵢ(<M) for a coding rate of Rᵢ, the block length and the coding rate of a generated block LDPC code can be defined by Equation (9) below.

$${N}_{i}^{′} = {N}_{i} - {P}_{i} < {N}_{i} , {R}_{i}^{′} = \frac{{N}_{i} - M}{{N}_{i} - {P}_{i}} > {R}_{i} = \frac{{N}_{i} - M}{{N}_{i}} \qquad ( 9 )$$

In order to generate a structured block LDPC code having a fixed block length, the number Pᵢ of punctured parity bits is optimally determined, so as to maintain the value of Nᵢ−Pᵢ=N₁ to be constant. In this case, the coding rate can be expressed by Equation (10) below.

$${R}_{i}^{″} = \frac{{N}_{i} - M}{{N}_{1}} \qquad ( 10 )$$

As described above, the most important factor in generating the structured block LDPC codes supporting variable coding rates is optimization of degree distribution. Further, when the number of supported variable coding rates is too many, the degree of the check node increases and the cycle characteristic degrades. Therefore, it is necessary to design the parity check matrix in consideration of the number of supported coding rates, noise threshold to be acquired, and cycle characteristics.

In the case of using structured block LDPC codes supporting various coding rates, that is, variable coding rates, a CQI transmission/reception system does not require an additional encoder or decoder for transmitting/receiving the CQI supporting various coding rates.

As described above, the present invention achieves reliable CQI transmission/reception which can minimize system overhead using structured block LDPC codes supporting variable coding rates for CQI transmission/reception in a BWA communication system.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for transmitting a signal in a signal transmission system, comprising:
demultiplexing a bit stream to be transmitted into a first bit stream and a second bit stream;
generating a first coded bit stream by coding the first bit stream according to a first coding rate and generating a second coded bit stream by coding the second bit stream according to a second coding rate; and
generating a coded symbol by concatenating the first coded bit stream and the second coded bit stream.

2. The method as claimed in claim 1, further comprising transmitting the coded symbol, wherein the bit stream to be transmitted is a bit stream which indicates Channel Quality Information (CQI).

3. A method for signal transmission in a communication system, comprising:
(1) receiving a signal through each of multiple bands, which includes at least one sub-carrier, and selecting a predetermined number of bands from the multiple bands;
(2) generating a first bit stream and a second bit stream, wherein the first bit stream indicates a central channel quality value among channel quality values of the selected bands, and the second bit stream indicates differences between the central channel quality value and channel quality values of bands other than the band having the central channel quality value;
(3) generating a first coded bit stream, which includes structured Low Density Parity Check (LDPC) codes, by coding the first bit stream according to a first coding rate, and generating a second coded bit stream, which includes structured LDPC codes, by coding the second bit stream according to a second coding rate; and
(4) generating a coded symbol by concatenating the first coded bit stream and the second coded bit stream.

4. The method as claimed in claim 3, further comprising transmitting the coded symbol, wherein the bit stream to be transmitted is a bit stream which indicates CQI, the first coding rate is determined in consideration of a number of entire bits and a target bit error rate of the first coded bit stream, and the second coding rate is determined in consideration of a number of entire bits and a target bit error rate of the second coded bit stream.

5. The method as claimed in claim 4, wherein, when the first bit stream includes 5 bits and the second bit stream includes 16 bits, the first coding rate is determined to satisfy conditions,
$$\frac{5}{{R}_{1}} + \frac{16}{{R}_{2}} \leq \frac{21}{R}$$
and P₂≦P,
wherein R₁ denotes the first coding rate, R₂ denotes the second coding rate, R denotes the coding rate applied to the coded symbol, P₂ denotes a target bit error rate of the second coded bit stream, and P denotes a target bit error rate of the coded symbol.

6. The method as claimed in claim 4, wherein, when the first bit stream includes 5 bits and the second bit stream includes 16 bits, the first coding rate is determined to satisfy conditions,
P₂≦P and
$$\frac{5}{{R}_{1}} + \frac{16}{{R}_{2}} \leq \frac{25}{R} ,$$
wherein P₂ denotes a target bit error rate of the second coded bit stream, P denotes a target bit error rate of the coded symbol, R₁ denotes the first coding rate, R₂ denotes the second coding rate, and R denotes the coding rate applied to the coded symbol.

7. The method as claimed in claim 5, wherein, in step (3), the first coded bit stream is generated by coding the first bit stream in accordance with a first parity check matrix generated according to the first coding rate, and the second coded bit stream is generated by coding the second bit stream in accordance with a second parity check matrix generated according to the second coding rate.

8. The method as claimed in claim 7, wherein the first parity check matrix and the second parity check matrix are generated by applying one of a shortening scheme and a puncturing scheme to a third parity check matrix which has been set in advance.

9. The method as claimed in claim 8, wherein each of the first parity check matrix and the second parity check matrix is a parity check matrix which has an optimized degree distribution.

10. The method as claimed in claim 6, wherein, in step (3), the first coded bit stream is generated by coding the first bit stream in accordance with a first parity check matrix generated according to the first coding rate, and the second coded bit stream is generated by coding the second bit stream in accordance with a second parity check matrix generated according to the second coding rate.

11. The method as claimed in claim 10, wherein the first parity check matrix and the second parity check matrix are generated by applying one of a shortening scheme and a puncturing scheme to a third parity check matrix which has been set in advance.

12. The method as claimed in claim 11, wherein each of the first parity check matrix and the second parity check matrix is a parity check matrix which has an optimized degree distribution.

13. A method for receiving a signal in a signal reception system, comprising:
demultiplexing a received coded symbol into a first coded bit stream and a second coded bit stream according to a first coding rate and a second coding rate having been applied by a signal transmission system;
generating a first bit stream and a second bit stream by decoding the first coded bit stream and the second coded bit stream according to the first coding rate and the second coding rate; and
restoring a bit stream by multiplexing the first bit stream and the second bit stream.

14. The method as claimed in claim 13, wherein the bit stream is a bit stream which indicates Channel Quality Information (CQI).

15. A method for receiving a signal in a signal reception system, comprising:
(1) demultiplexing a received coded symbol into a first coded bit stream and a second coded bit stream according to a first coding rate and a second coding rate having been applied by a signal transmission system;
(2) generating a first bit stream and a second bit stream by decoding the first coded bit stream and the second coded bit stream according to the first coding rate and the second coding rate by a structured block Low Density Parity Check (LDPC) decoding scheme, wherein the first bit stream indicates a central channel quality value among channel quality values of a predetermined number of bands selected from multiple bands, through which signals including at least one sub-carrier are transmitted from the signal transmission system, and the second bit stream indicates differences between the central channel quality value and channel quality values of bands other than the band having the central channel quality value; and
(3) restoring a bit stream by multiplexing the first bit stream and the second bit stream.

16. The method as claimed in claim 15, wherein the bit stream is a bit stream which indicates Channel Quality Information (CQI), and the first coding rate is determined in consideration of a number of entire bits and a target bit error rate of the first coded bit stream, and the second coding rate is determined in consideration of a number of entire bits and a target bit error rate of the second coded bit stream.

17. The method as claimed in claim 16, wherein, when the first bit stream includes 5 bits and the second bit stream includes 16 bits, the first coding rate is determined to satisfy conditions,
$$\frac{5}{{R}_{1}} + \frac{16}{{R}_{2}} \leq \frac{21}{R}$$
and P₂≦P,
wherein R₁ denotes the first coding rate, R₂ denotes the second coding rate, R denotes the coding rate applied to the coded symbol, P₂ denotes a target bit error rate of the second coded bit stream, and P denotes a target bit error rate of the coded symbol.

18. The method as claimed in claim 16, wherein, when the first bit stream includes 5 bits and the second bit stream includes 16 bits, the first coding rate is determined to satisfy conditions,
P₂≦P and
$$\frac{5}{{R}_{1}} + \frac{16}{{R}_{2}} \leq \frac{25}{R} ,$$
wherein P₂ denotes a target bit error rate of the second coded bit stream, P denotes a target bit error rate of the coded symbol, R₁ denotes the first coding rate, R₂ denotes the second coding rate, and R denotes the coding rate applied to the coded symbol.

19. The method as claimed in claim 17, wherein, in step (2), the first bit stream is generated by decoding the first coded bit stream in accordance with a first parity check matrix generated according to the first coding rate, and the second bit stream is generated by decoding the second coded bit stream in accordance with a second parity check matrix generated according to the second coding rate.

20. The method as claimed in claim 19, wherein the first parity check matrix and the second parity check matrix are generated by applying one of a shortening scheme and a puncturing scheme to a third parity check matrix which has been set in advance.

21. The method as claimed in claim 20, wherein each of the first parity check matrix and the second parity check matrix is a parity check matrix which has an optimized degree distribution.

22. The method as claimed in claim 18, wherein, in step (2), the first bit stream is generated by decoding the first coded bit stream in accordance with a first parity check matrix generated according to the first coding rate, and the second bit stream is generated by decoding the second coded bit stream in accordance with a second parity check matrix generated according to the second coding rate.

23. The method as claimed in claim 22, wherein the first parity check matrix and the second parity check matrix are generated by applying one of a shortening scheme and a puncturing scheme to a third parity check matrix which has been set in advance.

24. The method as claimed in claim 23, wherein each of the first parity check matrix and the second parity check matrix is a parity check matrix which has an optimized degree distribution.

25. A signal transmission system comprising:
a demultiplexer for demultiplexing a bit stream to be transmitted into a first bit stream and a second bit stream;
a controller for determining a first coding rate and a second coding rate to be applied to the first bit stream and the second bit stream;
an encoder for generating a first coded bit stream by coding the first bit stream according to the first coding rate and generating a second coded bit stream by coding the second bit stream according to the second coding rate; and
a transmitter for generating a coded symbol by concatenating the first coded bit stream and the second coded bit stream.

26. The signal transmission system as claimed in claim 25, wherein the transmitter transmits the coded symbol, and the bit stream to be transmitted is a bit stream which indicates Channel Quality Information (CQI).

27. A signal transmission system for signal transmission in a communication system, comprising:
a demultiplexer for demultiplexing a bit stream to be transmitted into a first bit stream and a second bit stream, wherein the first bit stream indicates a central channel quality value among channel quality values of a predetermined number of bands selected from multiple bands, through which signals including at least one sub-carrier are transmitted from the signal transmission system, and the second bit stream indicates differences between the central channel quality value and channel quality values of bands other than the band having the central channel quality value;
a controller for determining a first coding rate to be applied to the first bit stream and a second coding rate to be applied to the second bit stream;
a structured Low Density Parity Check (LDPC) coder for generating a first coded bit stream, which includes structured LDPC codes, by coding the first bit stream according to a first coding rate, and generating a second coded bit stream, which includes structured LDPC codes, by coding the second bit stream according to a second coding rate; and
a transmitter for generating a coded symbol by concatenating the first coded bit stream and the second coded bit stream.

28. The signal transmission system as claimed in claim 27, wherein the transmitter transmits the coded symbol, the bit stream to be transmitted is a bit stream which indicates CQI, and the controller determines the first coding rate in consideration of a number of entire bits and a target bit error rate of the first coded bit stream and determines the second coding rate in consideration of a number of entire bits and a target bit error rate of the second coded bit stream.

29. The signal transmission system as claimed in claim 28, wherein, when the first bit stream includes 5 bits and the second bit stream includes 16 bits, the first coding rate is determined by the controller to satisfy conditions,
$$\frac{5}{{R}_{1}} + \frac{16}{{R}_{2}} \leq \frac{21}{R}$$
and P₂≦P,
wherein R₁ denotes the first coding rate, R₂ denotes the second coding rate, R denotes the coding rate applied to the coded symbol, P₂ denotes a target bit error rate of the second coded bit stream, and P denotes a target bit error rate of the coded symbol.

30. The signal transmission system as claimed in claim 28, wherein, when the first bit stream includes 5 bits and the second bit stream includes 16 bits, the first coding rate is determined by the controller to satisfy conditions,
P₂≦P and
$$\frac{5}{{R}_{1}} + \frac{16}{{R}_{2}} \leq \frac{25}{R} ,$$
wherein P₂ denotes a target bit error rate of the second coded bit stream, P denotes a target bit error rate of the coded symbol, R₁ denotes the first coding rate, R₂ denotes the second coding rate, and R denotes the coding rate applied to the coded symbol.

31. The signal transmission system as claimed in claim 29, wherein the structured LDPC coder generates the first coded bit stream by coding the first bit stream in accordance with a first parity check matrix generated according to the first coding rate and generates the second coded bit stream by coding the second bit stream in accordance with a second parity check matrix generated according to the second coding rate.

32. The signal transmission system as claimed in claim 31, wherein the first parity check matrix and the second parity check matrix are generated by applying one of a shortening scheme and a puncturing scheme to a third parity check matrix which has been set in advance.

33. The signal transmission system as claimed in claim 32, wherein each of the first parity check matrix and the second parity check matrix is a parity check matrix which has an optimized degree distribution.

34. The signal transmission system as claimed in claim 30, wherein the structured LDPC coder generates the first coded bit stream by coding the first bit stream in accordance with a first parity check matrix generated according to the first coding rate and generates the second coded bit stream by coding the second bit stream in accordance with a second parity check matrix generated according to the second coding rate.

35. The signal transmission system as claimed in claim 34, wherein the first parity check matrix and the second parity check matrix are generated by applying one of a shortening scheme and a puncturing scheme to a third parity check matrix which has been set in advance.

36. The signal transmission system as claimed in claim 35, wherein each of the first parity check matrix and the second parity check matrix is a parity check matrix which has an optimized degree distribution.

37. A signal reception system comprising:
a demultiplexer for demultiplexing a received coded symbol into a first coded bit stream and a second coded bit stream according to a first coding rate and a second coding rate having been applied by a signal transmission system;
a decoder for generating a first bit stream and a second bit stream by decoding the first coded bit stream and the second coded bit stream according to the first coding rate and the second coding rate;
a controller for controlling the demultiplexer and the decoder in accordance with the first coding rate and the second coding rate; and
a multiplexer for restoring a bit stream by multiplexing the first bit stream and the second bit stream.

38. The signal reception system as claimed in claim 37, further comprising a receiver for generating the coded symbol, wherein the bit stream is a bit stream which indicates Channel Quality Information (CQI).

39. A signal reception system for receiving a signal in a signal reception system, comprising:
a demultiplexer for demultiplexing a received coded symbol into a first coded bit stream and a second coded bit stream according to a first coding rate and a second coding rate having been applied by a signal transmission system;
a structured block Low Density Parity Check (LDPC) decoder for generating a first bit stream and a second bit stream by decoding the first coded bit stream and the second coded bit stream according to the first coding rate and the second coding rate by a structured block LDPC decoding scheme, wherein the first bit stream indicates a central channel quality value among channel quality values of a predetermined number of bands selected from multiple bands, through which signals including at least one sub-carrier are transmitted from the signal transmission system, and the second bit stream indicates differences between the central channel quality value and channel quality values of bands other than the band having the central channel quality value; and
a controller for controlling the demultiplexer and the structured block LDPC decoder in accordance with the first coding rate and the second coding rate; and
a multiplexer for restoring a bit stream by multiplexing the first bit stream and the second bit stream.

40. The signal reception system as claimed in claim 39, further comprising a receiver for generating the coded symbol, wherein the bit stream is a bit stream which indicates Channel Quality Information (CQI), the first coding rate is determined in consideration of a number of entire bits and a target bit error rate of the first coded bit stream, and the second coding rate is determined in consideration of a number of entire bits and a target bit error rate of the second coded bit stream.

41. The signal reception system as claimed in claim 40, wherein, when the first bit stream includes 5 bits and the second bit stream includes 16 bits, the first coding rate is determined to satisfy conditions,
$$\frac{5}{{R}_{1}} + \frac{16}{{R}_{2}} \leq \frac{21}{R}$$
and P₂≦P,
wherein R₁ denotes the first coding rate, R₂ denotes the second coding rate, R denotes the coding rate applied to the coded symbol, P₂ denotes a target bit error rate of the second coded bit stream, and P denotes a target bit error rate of the coded symbol.

42. The signal reception system as claimed in claim 40, wherein, when the first bit stream includes 5 bits and the second bit stream includes 16 bits, the first coding rate is determined to satisfy conditions,
P₂≦P and
$$\frac{5}{{R}_{1}} + \frac{16}{{R}_{2}} \leq \frac{25}{R} ,$$
wherein P₂ denotes a target bit error rate of the second coded bit stream, P denotes a target bit error rate of the coded symbol, R₁ denotes the first coding rate, R₂ denotes the second coding rate, and R denotes the coding rate applied to the coded symbol.

43. The signal reception system as claimed in claim 41, wherein the structured LDPC decoder generates the first coded bit stream by coding the first bit stream in accordance with a first parity check matrix generated according to the first coding rate and generates the second coded bit stream by coding the second bit stream in accordance with a second parity check matrix generated according to the second coding rate.

44. The signal reception system as claimed in claim 43, wherein the first parity check matrix and the second parity check matrix are generated by applying one of a shortening scheme and a puncturing scheme to a third parity check matrix which has been set in advance.

45. The signal reception system as claimed in claim 44, wherein each of the first parity check matrix and the second parity check matrix is a parity check matrix which has an optimized degree distribution.

46. The signal reception system as claimed in claim 42, wherein the structured LDPC decoder generates the first coded bit stream by coding the first bit stream in accordance with a first parity check matrix generated according to the first coding rate and generates the second coded bit stream by coding the second bit stream in accordance with a second parity check matrix generated according to the second coding rate.

47. The signal reception system as claimed in claim 46, wherein the first parity check matrix and the second parity check matrix are generated by applying one of a shortening scheme and a puncturing scheme to a third parity check matrix which has been set in advance.

48. The signal reception system as claimed in claim 47, wherein each of the first parity check matrix and the second parity check matrix is a parity check matrix which has an optimized degree distribution.
